(19) United States
(12) Patent Application Publication
(10) Pub. No.: US 2026/0183089 A1
(43) Pub. Date: Jul. 2, 2026

(54) ALIGNER MADE BY JOINING EDGEWISE INDIVIDUAL POLYMER PIECES

(71) Applicant: Smylio Inc., Fremont, CA (US)

(72) Inventor: Loc Phan, Santa Clara, CA (US)

(21) Appl. No.: 19/436,918

(22) Filed: Dec. 30, 2025

Related U.S. Application Data
(60) Provisional application No. 63/741,334, filed on Jan. 2, 2025.

(51) Int. Cl. A61C 7/08; A61C 7/00; A61C 13/34

(52) U.S. Cl. CPC A61C 7/08; A61C 7/002; A61C 13/34; A61C 2201/00

(57) ABSTRACT

An orthodontic appliance has a shell-like shape adapted to receive teeth. The material forming the shell can be formed by linking multiple individual pieces together along their edges. The seam or interface defined between the linked pieces is arranged to align with an anatomically-based predetermined line across the occlusal surfaces along the dental arch. The location of the predetermined line, number, and types of individual polymer pieces can be selected to tune the amount of force and location of the force to move the teeth according to a treatment plan. Methods of making the appliance are also described.

### CROSS-REFERENCE TO RELATED APPLICATIONS

This claims priority to provisional application No. 63/741,334, filed Jan. 2, 2025, and entitled “ALIGNER MADE BY JOINING EDGEWISE INDIVIDUAL POLYMER PIECES.”

### FIELD OF THE INVENTION

The subject matter of the present disclosure relates generally to the field of orthodontic devices. More particularly, the present disclosure relates to aligners.

### BACKGROUND

An objective of orthodontics is to move a patient's teeth to positions where function and/or aesthetics are optimized. Traditionally, appliances such as braces are applied to a patient's teeth by a treating practitioner and the set of braces exerts continual force on the teeth and gradually urges them toward their intended positions. Over time and with a series of clinical visits and reactive adjustments to the braces by the practitioner, the appliances to move the teeth toward their final destination.

More recently, alternatives to conventional orthodontic treatment with traditional affixed appliances (e.g., braces) have become available. For example, systems including a series of molded plastic aligners have become commercially available from Align Technology, Inc., San Jose, Calif, under the trade name Invisalign® System. The Invisalign® System is described in numerous patents and patent applications assigned to Align Technology, Inc. including, for example in U.S. Pat. Nos. 6,450,807, and 5,975,893.

The Invisalign® System typically includes designing and fabricating multiple aligners to be worn by the patient before the aligners are administered to the patient and used to reposition the teeth (e.g., at the outset of treatment). Often, designing and planning a customized treatment for a patient makes use of computer-based 3-dimensional planning/design tools. The design of the aligners relies on computer modeling of the patient's teeth in a series of planned successive tooth arrangements, and the individual aligners are designed to be worn over the teeth, such that each aligner exerts force on the teeth and elastically repositions the teeth to each of the planned tooth arrangements.

Arguably, such aligners are less noticeable than traditional braces because typically aligners are constructed from a transparent material, however, many believe that aligners are easily noticeable due to the glossy sheen of the transparent material. Like traditional braces, aligners are required to be worn nearly constantly (20-22 hours a day), with breaks allowed for eating and cleaning teeth. Only small breaks are allowed because aligners do not have enough flexibility to account for teeth drifting out of alignment, which is based on physical and material characteristics of the aligner. Increasing the working tolerance to account for higher drift requires increasing the working elasticity of an aligner, i.e., the amount an aligner can stretch to mount to teeth without causing permanent deformation, but a highly elastic aligner typically will not provide enough force to move teeth required for orthodontic treatment.

Additionally, it is not uncommon for a treatment case to veer “off-track”. By “off-track” it is meant that the prescribed aligner no longer fits the patient dentition. This phenomenon can arise due to a number of reasons the most common being the patient failing to wear the device as prescribed. When a treatment case goes “off-track”, the typical course of action is to restart the treatment from the beginning. This, of course, is inconvenient and undesirable for the lost time and cost.

Additionally, it is estimated that over 80% of clear aligner cases experience midcourse correction (MCC) because of midcourse aligner unfit. The effect of Hooke's law and hysteresis cause aligner lag. Aligner lag arises from the dentition failing to move predictably according to each aligner's prescribed movement plan. Eventually the next aligner lacks the flexibility to fit the dentition.

Another challenge with conventional aligners is the inability to target specific forces at a localized dentition.

Another challenge is the limited fit range of current aligner materials—the fit range of current aligner materials is based on the flexural yield point of the material. Currently, to change this fit range, a more compliant and flexible material is compounded or laminated together with a stiff material into a sheet of material. The contribution is limited and not significant.

Such polymer-aligners cannot physically address the varying forces required for the various orthodontic tooth movements for different locations along the dental arch. Indeed, with reference to Table 1 below, various forces are desired for ideal orthodontic tooth movements for different locations along the dental arch. Wu et al., A biomechanical case study on the optimal orthodontic force on the maxillary canine tooth based on finite element analysis. Journal of Zhejiang University. Jul. 1, 2018.

TABLE 1

| Movement | Optimal force/moment | |
|---|---|---|
| Distal-direction translational | 130-137 | g |
| Distal-direction tipping | 40-44 | g |
| Labial-direction translational | 110-124 | g |
| Labial-direction tipping | 28-32 | g |
| Extrusion | 38-40 | g |
| Rotation around long axis | 170-210 | g · mm |

For at least the above-described challenges, a novel aligner material and aligner that overcomes the above-mentioned challenges is therefore desirable.

### SUMMARY OF THE INVENTION

Embodiments of the invention relate to orthodontic appliances, systems, and methods of use.

In some embodiments, an aligner material is made of different polymer pieces linked together along their edges to form a layer of material, and optionally, a single layer of uniform thickness.

In embodiments, the different polymer pieces are linked together by an interpenetrating polymer network (IPN), and optionally by heat or laser.

In embodiments, each of the independent different polymer pieces is in the form of a sheet.

In embodiments, an interface line or seam is formed where the different polymer pieces are linked together.

In embodiments, the seam or interface defined between the linked pieces is arranged to align with an anatomically-based predetermined line across the occlusal surfaces along the dental arch.

In embodiments, the location of the predetermined line, number, and types of individual polymer pieces can be selected to tune the amount of force and location of the force to move the teeth according to a treatment plan.

In embodiments, the multi-piece material is heat formed into a shell, optionally, single layer, over a model.

In other embodiments, each of the individual polymer pieces are heat formed over the model to form separate shells. The shells are then cut along a target seam, and the cut shells are aligned and linked together along their cut edges, thereby forming the shell. The shell is trimmed and cleaned.

In embodiments, the shell is polished or otherwise smoothed along the seam. Smoothing may be performed by a handheld tool such as a Dremel, or by a tumble polisher.

In embodiments, two pieces are linked along their edges to form the aligner sheet, and optionally, a polyurethane polymer sheet is linked to a polyethylene terethalate glycol polymer sheet.

In embodiments, three pieces are linked along their edges to form the aligner sheet, and optionally, a polyurethane polymer sheet is linked to a polyethylene terethalate glycol polymer sheet linked to a polyethylene vinyl acetate polymer sheet.

In embodiments, the shell includes one region made of a first material, a second region made of a second material different than the first material, such that the appliance applies varying forces along the dental arch.

In embodiments, the shell includes one region made of a first material, a second region made of a second material different than the first material, and a third material different than the first and second materials, such that the appliance applies varying forces along the dental arch.

In embodiments, the seam or interface for linking the separate polymer pieces is aligned with a predetermined or target seam.

In embodiments, the predetermined or target seam is based on biasing or causing specific movements for specific locations along the dental arch such as, for example, the forces and locations described above in Table 1.

### Objects and Advantages

In embodiments, the effect of the individual polymers on the dentitions are local and individualized over any particularly specified dentition.

In embodiments, since the linkages of the various polymers are along the individual edges of the sheets longitudinally, the effects of the polymers are localized over any particular specified part of the dentition. For example, the lingual part of the dentition requires more stiffness, a higher modulus polymer can be specified to be controlled over this part of the dentition.

In embodiments, the aligner can be fabricated out of various different materials that will exert their affects longitudinally.

In embodiments, the design allows for increased fit ranges without sacrificing available forces for moving teeth.

The description, objects and advantages of the present invention will become apparent from the detailed description to follow, together with the accompanying drawings.

### BRIEF DESCRIPTION OF THE DRAWINGS

For a better understanding of at least certain embodiments, reference will be made to the following Detailed Description, which is to be read in conjunction with the accompanying drawings.

FIG. 1 is a perspective view of a jaw and an orthodontic appliance, according to some embodiments.

FIG. 2 is a perspective view of a process for molding an orthodontic appliance, according to some embodiments.

FIG. 3A is a side view of a sheet formed by two polymer sheet pieces linked along their edges, according to some embodiments.

FIG. 3B is a top view of the sheet shown in FIG. 3A in the shape of a square, according to some embodiments.

FIG. 3C is a top view of the sheet shown in FIG. 3A in the shape of a circle, according to some embodiments.

FIG. 4 is an illustration of tooth anatomy and directional references.

FIGS. 5A, 5B are top and bottom views, respectively, of an orthodontic appliance formed of two polymer sheet pieces having an interface line arranged along the occlusal and incisal surfaces, according to some embodiments.

FIGS. 6, 7 are top views of an orthodontic appliance formed of three polymer sheet pieces having an interface line arranged along the occlusal and incisal surfaces, according to some embodiments.

FIG. 8 is an illustration of an orthodontic appliance formed of two polymer sheet pieces having interface lines separating the pre-molar and molar regions, according to some embodiments.

The figures depict various embodiments of the present invention for purposes of illustration only, wherein the figures use like reference numerals to identify like elements. One skilled in the art will readily recognize from the following discussion that alternative embodiments of the structures and methods illustrated in the figures may be employed without departing from the principles of the invention described herein.

### DETAILED DESCRIPTION

Before the present invention is described in greater detail, it is to be understood that this invention is not limited to particular embodiments described, as such can, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges can independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements or use of a “negative” limitation.

As will be apparent to those of skill in the art upon reading this disclosure, each of the individual embodiments described and illustrated herein has discrete components and features which can be readily separated from or combined with the features of any of the other several embodiments without departing from the scope or spirit of the present invention. Any recited method can be carried out in the order of events recited or in any other order that is logically possible.

Embodiments are disclosed that relate to orthodontic appliances constructed from multiple shells for the purpose of maximizing working elasticity. By “working elasticity” is it meant the capability of an orthodontic appliance to elastically deform to attach to an initial location of the teeth. This flexibility can allow an orthodontic appliance to obtain a greater range of initial tooth arranging (i.e., flexing) positions that differ from the appliance's target tooth arranging (i.e., resting) position. Possible benefits include greater break time (e.g., 8-12 hours) between required wear periods and greater latitude for patient non-adherence to required wear-times, and hence increased efficacy.

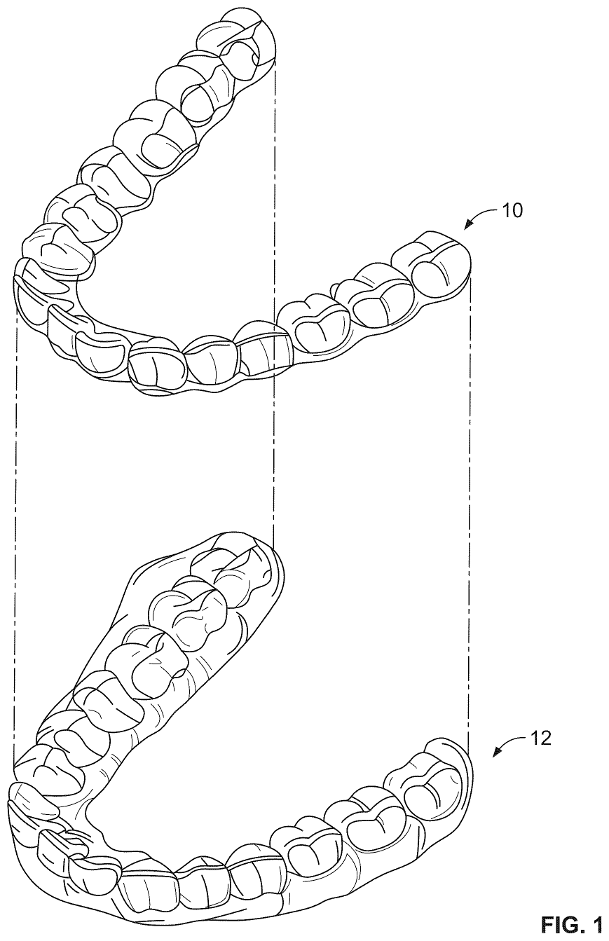

FIG. 1 is an exploded view of an orthodontic appliance 10 and jaw 12 of a patient, according to various embodiments of the present invention. An orthodontic appliance 10 can be worn by a patient in order to achieve an incremental repositioning of individual teeth in the jaw 12. The orthodontic appliance 10 can include a shell having teeth-receiving cavities that receive and resiliently reposition the teeth. In some embodiments, a polymeric appliance can be formed from one or more sheets or pieces of different polymers. An appliance can fit over all teeth present in an upper or lower jaw, or less than all of the teeth.

In some embodiments, only certain teeth received by an appliance will be repositioned by the appliance while other teeth can provide a base or anchor region for holding the appliance in place as it applies force against the tooth or teeth targeted for repositioning. In some cases, many or most, and even all, of the teeth will be repositioned at some point during treatment. Teeth that are moved can also serve as a base or anchor for holding the appliance as it is worn by the patient. Typically, no wires or other means will be provided for holding an appliance in place over the teeth. In some cases, however, it may be desirable or necessary to provide individual anchors on teeth with corresponding receptacles or apertures in the appliance so that the appliance can apply a selected force on the tooth. Basic methods for determining an orthodontic treatment plan using a series of incremented appliances as well as instructions for molding orthodontic appliances, are described in U.S. Pat. Nos. 6,450,807, and 5,975,893, which are incorporated by reference herein, but only to an extent that those patents do not contradict the newer teachings disclosed herein.

An appliance can be designed and/or provided as part of a set of a plurality of appliances. In such an embodiment, each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. A target tooth arrangement can be a planned final tooth arrangement selected for the patient's teeth at the end of all planned orthodontic treatment. Alternatively, a target arrangement can be one of many intermediate arrangements for the patient's teeth during the course of orthodontic treatment. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

The orthodontic appliances can be generated all at the same stage or in sets or batches, e.g., at the beginning of a stage of the treatment, and the patient wears each appliance until the pressure of each appliance on the teeth can no longer be felt or has resulted in the maximum amount of expressed tooth movement for that given stage. A plurality of different appliances (e.g., set) can be designed and even fabricated prior to the patient wearing any appliance of the plurality. After wearing an appliance for an appropriate period of time, the patient replaces the current appliance with the next appliance in the series until no more appliances remain. The orthodontic appliances are generally not affixed to the teeth and the patient may place and replace the appliances at any time during the procedure (e.g., patient-removable appliances).

The final orthodontic appliance or several appliances in the series may have a geometry or geometries selected to overcorrect the tooth arrangement, i.e., have a geometry which would (if fully achieved) move individual teeth beyond the tooth arrangement which has been selected as the “final.” Such over-correction may be desirable in order to offset potential relapse after the repositioning method has been terminated, i.e., to permit movement of individual teeth back toward their pre-corrected positions. Over-correction may also be beneficial to speed the rate of correction, i.e., by having an appliance with a geometry that is positioned beyond a desired intermediate or final position, the individual teeth will be shifted toward the position at a greater rate. In such cases, the use of an appliance can be terminated before the teeth reach the positions defined by the appliance.

The materials and size of the orthodontic appliance may vary.

For embodiments, the non-limiting exemplary appliance thickness ranges from 0.001-0.040 inches, and in embodiments, from 0.025-0.035 inches. For embodiments where the appliance includes multiple sheets or layers, the thickness of each of the individual layers is adjusted (namely, decreased) so that the total thickness of the combination of the layers ranges from 0.001-0.040 inches, and in embodiments, from 0.025-0.035 inches.

Exemplary materials for the sheets can include, without limitation, a polyester, a co-polyester, a polycarbonate, a polyurethane, a thermoplastic polyurethane (TPU), a polypropylene, a polyethylene, a polypropylene and polyethylene copolymer, an acrylic, a cyclic block copolymer, a polyetheretherketone, a polyamide, a polyethylene terephthalate, a polybutylene terephthalate, a polyetherimide, a Polyethylene Terethalate Glycol, a Polymethylmethacrylate, a Polyvinyl acetate, a Polyvinyl chloride, a polyethersulfone, a polytrimethylene terephthalate or a combination thereof.

In some embodiments, shells are coated with lubricous materials or provided with surface treatments to decrease friction between the shells. In some embodiments, the shells are treated with hydrophobic coatings. In some embodiments, shells of relatively more flexibility can be used in conjunction with stiffer shells. Flexible shells can be constructed from hydrogels, styrenic block copolymers (SBC), silicone rubbers, elastomeric alloys, thermoplastic elastomers (TPE), thermoplastic vulcanizate (TPV) elastomers, polyurethane elastomers, block copolymer elastomers, polyolefin blend elastomers, thermoplastic co-polyester elastomers, thermoplastic polyamide elastomers, or a combination thereof.

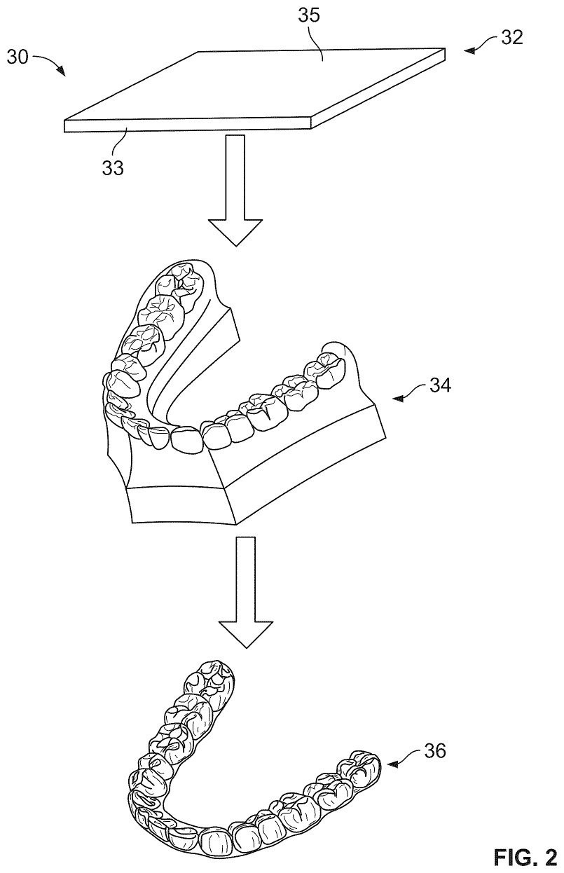

FIG. 2 depicts an example of a process 30 for forming an orthodontic appliance, according to embodiments of the invention. As shown, a sheet 32 can be formed into an orthodontic appliance 36. The sheet 32 can be in the form of one layer or sheet including at least one longitudinal edge 33 and a horizontal surface 35. It may be used, as described herein, to form a shell or multiple non-affixed layers to form multiple shells at once. In this example process, the tooth positioning appliance 36 can be produced with the use of a physical tooth model, or mold, 34. The tooth positioning appliance 36 can be produced by heating the thermoformable sheet 32 and then vacuum or pressure forming it over the teeth in the physical tooth model 34. The tooth positioning appliance 36 is a direct representation of the physical tooth model. In some embodiments, sheet 32 is dimensioned (e.g., 120 mm and/or 125 mm diameter circle) for ready processing on a commercially available forming device (e.g., Erkoform®, Erkoform-3Dmotion®, Biostar®, Ministar S®, Drufomat Scan®, Drufosmart®, Essix® SelectVac®). Guidelines for operating such forming devices can be found at Scheu Dental Technology, Biostar Operating Manual, DE/GB/FR/IT/ES/1.000/06/19 G REF PM 0113.01; Scheu Dental Technology, Application booklet for the pressure moulding technique, GB 2.000/07/19 G REF 0111.02; Erkodent, Thermoforming, S15-3106-48; Erkodent, Erkoform 3D, 61-8002-2; Erkodent, Erkoform-3D+Instructions, BA-Erkoform-3d+-anl-EN-04-04-2019, which are incorporated by reference herein.

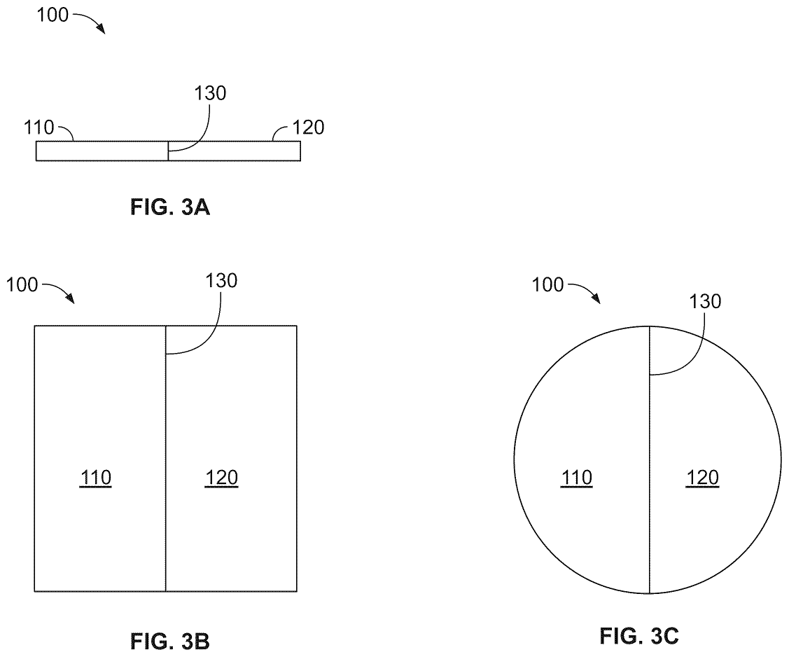

FIGS. 3A-3B are various views of one sheet 100 formed by two polymer sheets or pieces 110, 120 joined along their longitudinal edges forming an interface line or seam 130. In the embodiment shown in FIGS. 3A, 3B, the two polymer sheet pieces 110, 120 have the same thickness, thus forming a continuous uniform thickness sheet 100. In preferred embodiments, the interface 130 is formed by an interpenetrating polymer network (IPN).

FIG. 3C is a top view of the sheet 100 shown in the shape of a circle. The shape formed by joining the separate sheet pieces may take a wide range of shapes including, for example, a circle, square, rectangle, hemisphere, ellipse and arcuate.

### Forming Interpenetrating Polymer Network (IPN)

In embodiments, the polymers of the two opposing sides are IPN linked at their longitudinal ends. An Interpenetrating polymer network (IPN) is a polymer comprising two or more networks which are at least partially interlaced on a polymer scale but not covalently bonded to each other.

The IPN may be formed using heat. The heat source may be, for example, a heated tool or a laser. In some embodiments, the IPN may be formed using a theta-solvent of the multiple polymers, or any other solvent or solvent mixture may be used in which the polymers are soluble. Additionally, the IPN may be formed using ultrasonic welding.

### Teeth Anatomy and Directional Reference

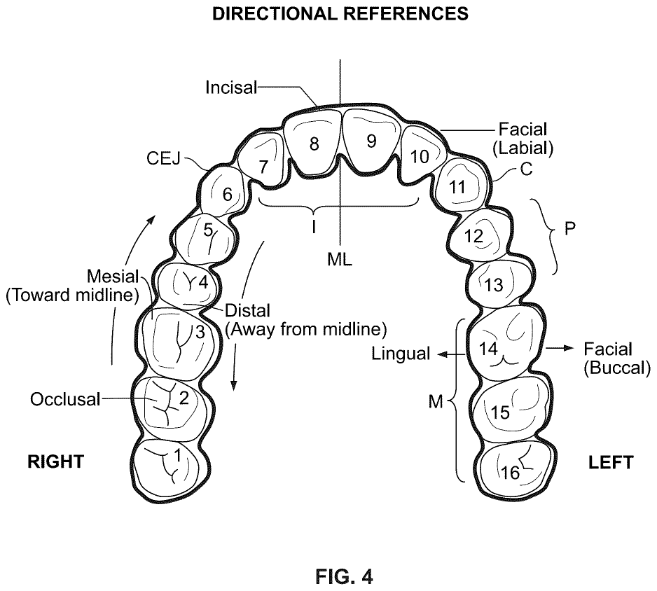

Now with reference to FIG. 4, teeth anatomy and directional references are illustrated to facilitate understanding of the specific embodiments of the invention described herein. The teeth are shown arranged according to conventional numbering 1-16 where the teeth on the right side are numbered 1-8 and the teeth on the left side are numbered 9-16.

Arrows are shown to indicate lingual versus facial directions.

Arrows are shown to indicate distal versus mesial direction, relative to the midline (ML).

Midline is indicated by (ML), and separates the left and right side.

Incisal and occlusal surfaces are labelled.

Incisors are labelled I.

The left side canine is labelled C.

The left side premolars are labelled P.

The left side molars are labeled M.

The right side teeth are symmetric to the left and would have labels corresponding to the left side labels (namely, C, P, and M) where not shown in the figure.

Additionally, the cementoenamel junction (CEJ) is the location where the enamel, which covers the anatomical crown of a tooth, and the cementum, which covers the anatomical root of a tooth, meet. Informally it is known as the neck of the tooth. In embodiments, the orthodontic appliance is trimmed after it is formed into shape in the vicinity of this feature.

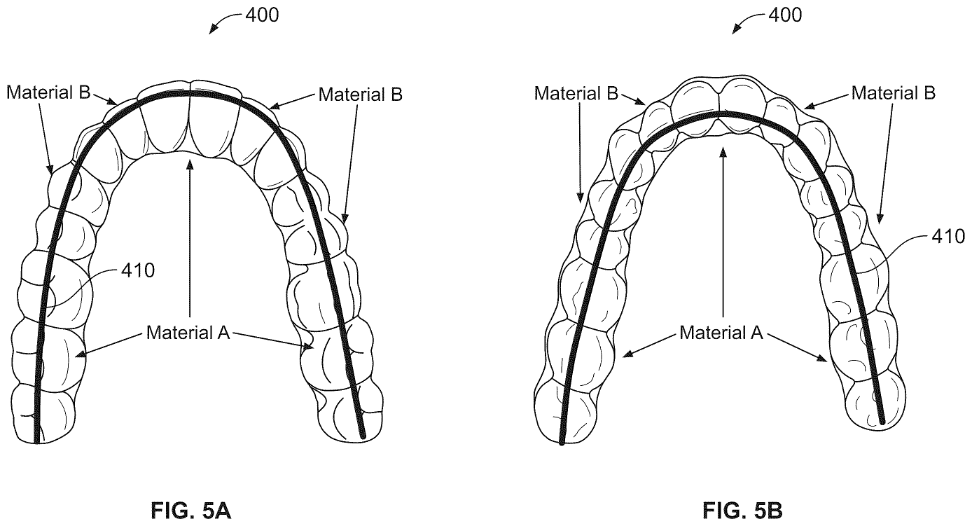

FIGS. 5A-5B are top and bottom views, respectively, of an orthodontic appliance 400 formed of two polymer sheet pieces, according to embodiments of the invention. The orthodontic appliance 400 is formed of a first polymer sheet (Material A) and a second polymer sheet (Material B) joined along an interface line 410, preferably an IPN, as described above in connection with FIG. 3. First piece (Material A) is shown on the lingual side and second piece (Material B) is shown on the facial or labial side. The interface line 410 extends continuously from the right molar to the left molar, across the occlusal and incisal surfaces.

Canine Extraction. In embodiments, the material on the lingual side is less strong than that of the labial side, serving to facilitate specific movement of the premolars and incisors for treatment to close an open space arising from removal of a canine (C) in a canine extraction case. In embodiments, a stronger material such as PET glycol or polycarbonate is used on the labial side and a weaker material such as polyurethane is implemented on the lingual side.

Arc expansion. In embodiments, the material on the lingual side is selected to be stronger than that of the labial side, serving to move posterior teeth (e.g., molars and premolars).

In embodiments, the separate sheet pieces are joined along their edges at a seam; the seam is then arranged along the model to correspond with a predetermined target seam, and the construct is heated to shape the material into a shell having the shape of the model and an interface line formed along the target interface line. Excess material is trimmed.

In other embodiments, each of the individual sheet pieces (e.g., Material A and Material B) are separately formed into an independent shell in the shape of the model, and each shell is cut along the target/desired seam. The separate halves are then joined at the cut edges, forming an interface line along the target seam. Excess material is then trimmed.

In embodiments, the target seam and material selection are determined in advance based on the prescription. Based on which teeth are to desired to be moved, and displacement desired, the seam location and materials are selected.

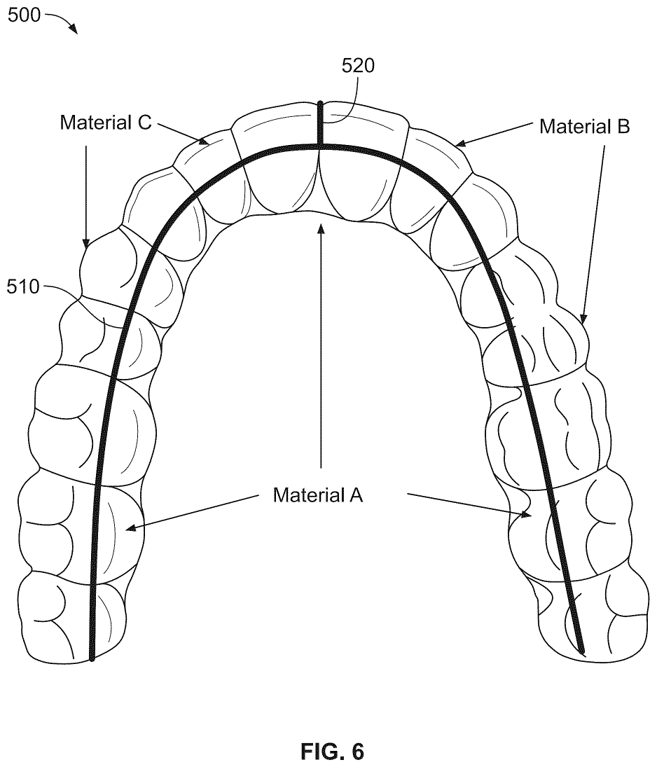

FIG. 6 is a top view of an orthodontic appliance formed of three polymer sheet pieces, according to some embodiments. The orthodontic appliance 500 is formed of a first polymer sheet (Material A), a second polymer sheet (Material B), and a third polymer sheet (Material C) joined along interface lines 510, 520, preferably an IPN, as described above in connection with FIG. 3.

Material A is shown on the lingual side and Material B, Material C are shown on the left and right labial sides, respectively. The interface line 510 extends from the right molar to the left molar, across the occlusal and incisal surfaces wherein the interface line is slightly biased lingually in both the incisal and molar regions. The second interface line 520 is arranged in the incisal region, and extends along the midline in the labial direction (or facially).

In embodiments, where Material A is stronger than Materials B and C, increased forces are applied to move the arch outwards. Additionally, in embodiments, where Material B is stronger than Material C, the arch shall be pushed towards the less strong material, or in this example, towards Material C or the right side.

By selecting the number of pieces, the material types, and the seam(s) where the pieces are joined, a wide range of focused movements can be applied to the dental arch and teeth.

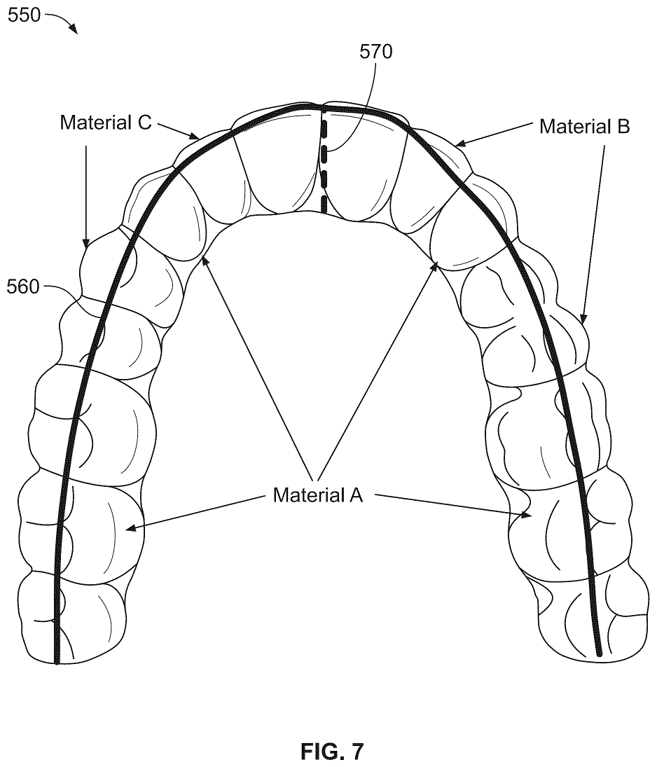

FIG. 7 is an orthodontic appliance 550 formed of a first polymer sheet (Material A), a second polymer sheet (Material B), and a third polymer sheet (Material C) joined along interface lines 550, 560, preferably an IPN, as described above in connection with FIG. 3.

Material A is shown on the lingual side and Material B, Material C are shown on the left and right labial side, respectively. The interface line 560 extends from the right molar to the left molar, across the occlusal and incisal surfaces wherein the interface line is generally more centered across the tops of the teeth than that shown in FIG. 6. The interface line 570 is arranged in the incisal region, and extends along the midline in the labial direction (or facially).

By selecting the number of polymer pieces, the material types, and the seam(s) where the pieces are joined, a wide range of focused movements can be applied to the dental arch and teeth.

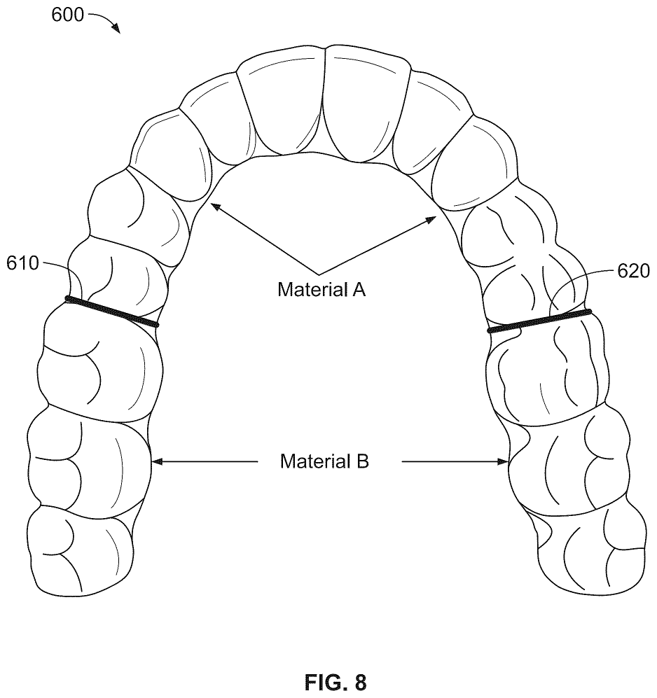

FIG. 8 is a top view of another orthodontic appliance formed of two polymer sheets, according to embodiments of the invention.

FIG. 8 is an orthodontic appliance 600 formed of a first polymer sheet (Material A) and a second polymer sheet (Material B) joined along two interface lines 610, 620, preferably an IPN, as described above in connection with FIG. 3. The interface lines 610, 620 are shown separating the premolars and molars. Material B is shown in the molar region. Material A is shown in the premolar, canine and incisal regions, (or stated alternatively, mesial to the molar region).

In embodiments, and with reference to FIG. 8, a stronger material may be selected for Material B, anchoring the appliance to the molars. Consequently, the sections of the dental arch captured by Material A (namely, the incisal, canines, and premolars) would be drawn distally.

In embodiments, the seams are selected between canine and premolars.

In embodiments, the seams are selected between canine and incisors.

In embodiments, the seams are selected between incisors.

Indeed, by selecting the number of pieces, the material types, and the seam(s) where the pieces are joined, a wide range of focused movements can be applied to the dental arch and teeth.

### Prescription/Treatment Plan

One or a series of physical tooth models, such as the model described above, may be used in the generation of elastic repositioning appliances for orthodontic treatment. Similar to the process described above with reference to FIG. 3, each of the appliances can be generated by thermoforming a multi-piece polymeric material over a mold of a desired tooth arrangement to form a dental appliance. The tooth positioning appliance of the desired tooth arrangement generally conforms to a patient's teeth but is slightly out of alignment with the initial tooth configuration. Placement of the elastic positioner over the teeth applies controlled forces in specific locations to gradually move the teeth into the desired configuration. Repetition of this process with successive appliances comprising new configurations eventually moves the teeth through a series of intermediate configurations to a final desired configuration.

### Alternative Embodiments

It is to be understood the invention may vary widely and is intended to include any one feature or combination of features described above except where the invention is explicitly limited in any appended claims.

For example, different parts of the aligner are composed of varying polymer formulations. The specific polymer at any location of the aligner can be selected based on the specific force needed at that location. For example, the buccal side of the aligner can be composed of a different polymer from the lingual side of the aligner. The independent polymer pieces may be IPN linked along a seam across the occlusal surface or another tooth location or landmark. Configurations may include, without limitation, forming an interface on the left side of the aligner, the right side of the aligner, the labial side of the aligner, the lingual side of the aligner, or any combination thereof.

Additionally, and although reference was made to a lower shell to contact the teeth corresponding generally to an orthodontic appliance for treating the teeth in the lower jaw, the invention is equally applicable and relevant to treating the teeth in the upper jaw. Indeed, embodiments of the invention are intended to cover orthodontic appliances to move and treat the teeth in the upper or lower jaws as the case may be.

Additionally, although some of the above-described embodiments of the invention show and describe a single layer appliance formed of multiple polymer pieces, the invention is not intended to be so limited except where explicitly recited in any appended claims. Embodiments of the invention may comprise an appliance made of several layers, and in some embodiments, one or more of the individual layers can include linked pieces of different polymers.

For embodiments, an aligner comprises two or more stacked layers, wherein each layer comprises a sheet formed from edgewise linking pieces of different polymers as described herein. Additionally, in some embodiments, the layers are formed together as a laminate or integrated product. In embodiments, the layers are attached to one another at discrete locations, and in some embodiments, along a perimeter such that a gap is present between the layers. In one embodiment, an aligner includes two layers affixed to one another along the perimeter such that a thin gap is present between the layers within the perimeter, wherein the gap ranges from 10 to 100 mils.

Throughout the foregoing description, and for the purposes of explanation, numerous specific details are set forth in order to provide a thorough understanding of the described techniques. It will be apparent, however, to one skilled in the art that these techniques can be practiced without some of these specific details. Although various embodiments that incorporate these teachings have been shown and described in detail, those skilled in the art could readily devise many other varied embodiments or mechanisms to incorporate these techniques. Also, embodiments can include various operations as set forth above, fewer operations, or more operations; or operations in an order. Accordingly, the scope and spirit of the invention should be judged in terms of the claims, which follow as well as the legal equivalents thereof.

1. An orthodontic appliance for repositioning a patient's teeth along the dental arch according to a treatment plan, the appliance comprising:
a 3D dimensional shape;
a first layer of material comprising multiple pieces linked edgewise; and
wherein at least two of the pieces are made of different polymers.

2. The appliance of claim 1, wherein a seam or interface is defined between the linked pieces.

3. The appliance of claim 2, wherein the seam is arranged and located in the appliance to extend, when worn by the patient, in a continuous line along the dental arch, and optionally, along the occlusal surface from one side of the dental arch to the opposite side of the dental arch.

4. The appliance of claim 3, wherein the number of pieces, and types of polymers are selected to tune the amount of force and location of the force to move the teeth according to the treatment plan.

5. The appliance of claim 1, comprising at least 3 individual pieces.

6. The appliance of claim 1, wherein the multiple pieces are linked as an interpenetrating network (IPN).

7. The appliance of claim 6, wherein the multiple pieces are joined by heat or laser.

8. The appliance of claim 7, wherein each of the multiple polymer pieces is a sheet.

9. The appliance of claim 8, wherein the sheets, when joined, form one continuous sheet of uniform thickness.

10. The appliance of claim 1 wherein at least one of the pieces is made from a copolymer, and optionally, an A-B-A copolymer.

11. The appliance of claim 1, wherein at least one of the pieces is made from a polymer selected from polyurethane, polycarbonate, PET glycol, polymethylmethacrylate, polyvinyl acetate, polyvinyl chloride, polyester, and co-polyester.

12. The appliance of claim 1, further comprising a second layer of material arranged over the first layer.

13. A method for forming an orthodontic appliance based on a patient treatment plan, the method comprising:
providing a plurality of independent sheets differing from one another in polymer type;
thermo-forming each of the sheets into a shell based on a patient model for the treatment plan;
cutting each of the shells into pieces along an anatomically-based predetermined interface line; and
fitting together according to the predetermined interface line the pieces of different shells into one multi-piece shell; and
joining the pieces together.

14. The method of claim 13, wherein the joining forms an IPN, and optionally wherein joining is by heating.

15. The method of claim 13, further comprising fixedly arranging a second layer of material over the first layer.

16. A method for forming an orthodontic appliance based on a patient treatment plan, the method comprising:
providing a plurality of independent sheets differing from one another in polymer type and each comprising an edge;
joining the independent sheets along the edges, defining a seam, and forming one continuous multi-piece sheet;
providing a patient model for the treatment plan;
arranging the multi-piece sheet over the model, and aligning the seam along an anatomically-based predetermined interface line of the model; and
thermo-forming the multi-piece sheet into a shell of the patient model.

17. The method of claim 16, further comprising fixedly arranging a second layer of material over the first layer.

18. The method of claim 17, wherein the second layer comprises multiple pieces linked edgewise.

19. The method of claim 18, wherein a seam is defined between the linked pieces of the first and second layers, and the method further comprising arranging and locating the seam in the appliance to extend, when worn by the patient, in a continuous line along the dental arch.

20. The method of claim 19, wherein the continuous line is arranged on the aligner to extend, when worn by the patient, along the occlusal surface from one side of the dental arch to the opposite side of the dental arch.
